(19) United States
(12) Patent Application Publication
(10) Pub. No.: US 2026/0112724 A1
(43) Pub. Date: Apr. 23, 2026

(54) Rapid Cooling and Strong Heat Insulation Device and Method for Emergency Disposal After Thermal Runaway Warning of Energy Storage Lithium-Ion Battery

(71) Applicant: Nanjing Tech University, Nanjing City (CN)

(72) Inventors: Zhirong Wang, Nanjing City (CN); Jialong Liu, Nanjing City (CN); Jialei Liu, Nanjing City (CN); Xiaoming Jin, Nanjing City (CN)

(21) Appl. No.: 19/360,974

(22) Filed: Oct. 16, 2025

(30) Foreign Application Priority Data
Oct. 21, 2024 (CN) 202411470480.8

(51) Int. Cl. H01M 10/633; G08B 21/18; H01M 10/613; H01M 10/6557; H01M 10/6568; H01M 10/6569; H01M 10/658; H01M 50/262; H01M 50/271; H01M 50/291; H01M 50/293

(52) U.S. Cl. CPC H01M 10/633; H01M 10/613; H01M 10/6557; H01M 10/6568; H01M 10/6569; H01M 10/658; H01M 50/262; H01M 50/271; H01M 50/291; H01M 50/293; G08B 21/182; G08B 21/185; H01M 2200/10

(57) ABSTRACT

Disclosed is a rapid-cooling and heat-insulating device and method for emergency disposal after a thermal-runaway warning of energy-storage lithium-ion batteries. The device includes a battery-pack case, multiple cooling and heat-insulating modules, a bottom liquid-cooling plate, a cooling system, and a thermal-runaway processing module. Each cooling and heat-insulating module has two liquid-cooling plates with an aerogel sheet sandwiched between them. A battery pack is tightly inserted between two adjacent modules. The condenser and compressor preliminarily cool the cooling medium, while semiconductor devices and phase-change materials assist in cooling branch pipelines. In operation, one liquid-cooling plate contacts the side surface of a battery row to rapidly cool it after a warning, preventing thermal runaway. When thermal runaway occurs, the aerogel sheet and the other liquid-cooling plate block heat transfer to neighboring batteries, thereby suppressing propagation of thermal runaway within the pack.

### TECHNICAL FIELD

The present invention belongs to the field of battery management technology, and specifically relates to a rapid cooling and strong heat insulation device and method for emergency disposal after thermal runaway warning of energy storage lithium-ion batteries.

### BACKGROUND ART

Lithium-ion batteries are excellent electrical energy storage devices. They possess advantages such as high energy density, high voltage, no memory effect, and long cycle life, and thus are widely used in electrochemical energy storage stations. However, safety issues of energy storage batteries remain one of the urgent problems to be solved during their use. An energy storage lithium-ion battery generates a large amount of heat after thermal runaway, exhibits high combustion rate upon ignition, and may explode, leading to severe accident consequences. Zhang et al. pointed out that existing battery materials and manufacturing processes cannot completely prevent the occurrence of thermal runaway in lithium-ion batteries. Thermal runaway warning is crucial for fire prevention and control of lithium-ion batteries and has therefore been extensively studied, resulting in numerous warning technologies. However, effective emergency disposal methods after a thermal runaway warning have rarely been researched, and there is currently a lack of effective emergency measures. Furthermore, blocking thermal runaway propagation is the first line of defense after a single battery cell undergoes thermal runaway to prevent further escalation of accidents, making it particularly important in controlling lithium-ion battery thermal runaway incidents.

Effective heat dissipation of a battery cell after thermal runaway warning can, to some extent, prevent the occurrence of thermal runaway. If thermal runaway of a single battery cell cannot be prevented, thermal barrier methods can suppress heat transfer to surrounding cells, thereby inhibiting the propagation of thermal runaway. Traditional battery thermal management technologies mainly include air-cooling and liquid-cooling systems, but both have certain limitations in preventing thermal runaway and suppressing its propagation. Air has a low heat transfer coefficient and may even fail to meet the heat dissipation requirements of lithium-ion battery packs under high-rate charge-discharge conditions, and has gradually been replaced by liquid-cooling thermal management technology. However, as the coolant flows from inlet to outlet, it continuously absorbs heat from the batteries, causing its temperature to rise progressively, making it difficult to achieve uniform heat dissipation across all batteries within the battery pack. CN215008362U discloses a rapid cooling device for low-temperature testing of lithium-ion batteries, including a thermally insulated enclosure containing a cooling element that clamps the lithium-ion battery and contacts its surface, the cooling element being connected via pipelines to a cooling medium supply unit, with a cooling unit fixedly provided on the side facing the battery. Although the present invention proposes a scheme where the cooling unit contacts the battery for heat dissipation, it only applies a plurality of cooling units to a single battery for testing purposes and is not practically applicable in industrial settings.

Current methods for suppressing lithium-ion battery thermal runaway propagation include spraying extinguishing agents, placing thermal barrier materials between batteries, and using liquid nitrogen cooling. Patent CN207199806U proposes placing layered insulating sheets between adjacent batteries to slow down heat propagation to neighboring cells. CN114887272A proposes a preparation method for hydrated inorganic salt dry powder extinguishing agents and analyzes their role in suppressing thermal runaway propagation, showing effective suppression. Huang et al. proposed spraying liquid nitrogen after battery thermal runaway to suppress propagation. Results show that liquid nitrogen can rapidly reduce battery temperature, thus inhibiting inter-cell thermal runaway propagation. However, spraying extinguishing agents or liquid nitrogen requires dedicated piping systems and equipment, and water-based extinguishing agents may cause short circuits in battery packs. Placing insulating materials between batteries does not consider heat dissipation, potentially leading to heat accumulation within the battery pack.

CN105742755A proposes a “sandwich”-structured composite plate composed of a heat-conducting shell, phase change material, and isolation board, capable of providing both insulation and heat dissipation. However, the stability of phase change materials decreases over prolonged system operation, requiring extensive experimentation to verify heat dissipation stability, and once the absorbed heat cannot be dissipated, the phase change material loses its heat absorption capability. Therefore, there is an urgent need to solve the problem of heat dissipation after battery thermal runaway warning and the contradiction between battery pack heat dissipation and thermal runaway isolation, so as to dissipate the heat generated by the battery to the outside of the battery pack while blocking heat transfer among battery cells, thereby preventing battery thermal runaway or suppressing the propagation of thermal runaway within the battery pack.

### SUMMARY OF THE INVENTION

An objective of the present invention is to solve the problems of lack of emergency disposal technology after lithium-ion battery thermal runaway warning and the contradiction between battery pack heat dissipation and thermal runaway blocking, overcoming deficiencies of existing technologies in practical applications.

In order to solve the above problems and achieve the objective of the present invention, a technical solution of the present invention is: a rapid cooling and strong heat insulation device for emergency disposal after thermal runaway warning of energy storage lithium-ion batteries, which includes: a battery pack case provided with a slidable top cover plate, wherein one sidewall is provided with a plurality of through-holes;

n+1 cooling and heat insulation modules provided in the battery pack case, each comprising two liquid cooling plates and one aerogel sheet, with the aerogel sheet sandwiched between the two liquid cooling plates, both ends being clamped together as a whole by metal hoops, each liquid cooling plate being provided with a first inlet and a first outlet, and the liquid cooling plate internally provided with a first liquid cooling pipeline communicating with the first inlet and the first outlet, for inputting and outputting a coolant; n being a positive integer.

A bottom liquid cooling plate laid on an inner bottom plate of the battery pack case, the bottom liquid cooling plate being provided with a second inlet and a second outlet, and internally provided with a second liquid cooling pipeline communicating with the second inlet and the second outlet, for inputting and outputting the coolant; wherein the n+1 cooling and heat insulation modules are provided in a row on the bottom liquid cooling plate, with a set of battery packs tightly inserted between two adjacent cooling and heat insulation modules, resulting in a total of n sets of battery packs.

A cooling system for circulating the coolant to the liquid cooling plate and the bottom liquid cooling plate, comprising a coolant storage tank, and a water pump, a compressor, a radiator, a condenser and a main pipeline which are sequentially connected via pipelines using the coolant from the coolant storage tank; wherein the main pipeline delivers the coolant to the bottom liquid cooling plate and then circulates back to the coolant storage tank, while another branch passes through an angle valve diverter, n+1 branch solenoid valves, and n+1 branch pipelines to deliver the coolant to each liquid cooling plate before returning to the coolant storage tank; all the branch solenoid valves are normally closed valves. The first inlets and first outlets of the liquid cooling plates of each cooling and heat insulation module, as well as the second inlet and second outlet of the bottom liquid cooling plate, extend out of the battery pack case through the through-holes and connect to fluid delivery pipelines.

A thermal runaway processing module comprising temperature sensors provided inside the battery pack case for detecting the temperature of the battery packs, and a processor and n+1 branch solenoid valve drive circuits provided outside the battery pack case; one temperature sensor is provided at each battery pack, each temperature sensor having a unique identification number consistent with positional information of the corresponding battery pack; a signal output terminal of each temperature sensor is electrically connected to a corresponding signal input terminal of the processor, the n+1 branch solenoid valve drive circuits being respectively electrically connected to the signal output terminal of the processor, each branch solenoid valve having a unique identification number, the identification number of the temperature sensor installed at each battery pack being associated with the identification numbers of the two branch solenoid valve drive circuits of the adjacent cooling and heat insulation modules, each branch solenoid valve drive circuit being electrically connected to one branch solenoid valve; when the temperature sensor detects that the temperature of any battery pack exceeds a thermal runaway warning temperature, the processor issues a command to activate the associated branch solenoid valve drive circuit to open the corresponding branch solenoid valve.

In the present invention, in the rapid cooling and strong heat insulation module, one liquid cooling plate is closely attached to a side surface of a row of batteries, thereby enabling rapid cooling of the batteries after a thermal runaway warning, preventing the occurrence of battery thermal runaway. When battery thermal runaway occurs, the aerogel sheet and the other liquid cooling plate prevent heat transfer from the thermally runaway battery to adjacent batteries, thus suppressing the propagation of thermal runaway within the battery pack. The present invention resolves the contradiction between thermal runaway blocking and heat dissipation in energy storage battery packs, has no adverse impact on the normal operation of the battery energy storage system, and remains functional and reusable even in cases of false or missed thermal runaway warnings.

Preferably, a thickness of the aerogel sheet is less than 2 mm, and a silica aerogel composite material selected has a thermal conductivity coefficient of less than 0.02 W/(m⋅K) and an elastic modulus of greater than 1500 kPa.

Preferably, a material of the liquid cooling plate is a metal having a thermal conductivity coefficient of greater than 200 W/m⋅K, and a material of the liquid cooling pipeline is a metal having a thermal conductivity coefficient of greater than 300 W/m⋅K.

Preferably, a thickness of each cooling and heat insulation module is less than one-quarter of a thickness of each battery pack.

Preferably, the cooling system circulates a coolant selected from distilled water or ethylene glycol aqueous solution, and a circulation flow rate V shall satisfy that the heat dissipation efficiency of the liquid cooling plate or the bottom liquid cooling plate is greater than or equal to 1° C./min, and the circulation flow rate V shall also satisfy that the battery pack operates at a maximum temperature lower than 40° C.

Preferably, the coolant in the coolant storage tank shall satisfy a supply capacity of more than 6 minutes under the circulation flow rate V without reflux; a maximum flow rate of the coolant provided by the water pump is greater than or equal to the circulation flow rate V.

Preferably, the cooling system further comprises a semiconductor device and a phase change material, which are attached and wrapped on each branch pipeline for cooling and reducing a temperature of the branch pipelines.

The above measures are all intended to improve thermal conductivity and heat transfer efficiency. Preferably, elastic protrusions are provided on inner walls of two side panels of the battery pack case, the two side panels being adjacent to a side panel provided with the through-holes; the through-holes are any one or a combination of more than one of circular holes, oval holes and square holes. Providing elastic protrusions on the side panels can not only mitigate the impact of external forces on the battery pack and the cooling and heat insulation module but also ensure tight contact between the battery pack and the cooling and heat insulation module.

A control method for rapid cooling and strong heat insulation emergency disposal after thermal runaway warning of lithium-ion batteries, wherein based on the rapid cooling and strong heat insulation device for emergency disposal after thermal runaway warning of energy storage lithium-ion batteries described above, setting the thermal runaway warning temperature of the energy storage lithium-ion battery as T, the specific control method comprising the following steps:

### S1: Detection:

acquiring in real time, by each temperature sensor, a temperature t of a corresponding battery pack and transmitting same to the processor;

### S2: Judgment:

after receiving the real-time temperatures acquired by respective temperature sensors, comparing, by the processor, the real-time temperatures with a thermal runaway warning temperature T; if the temperature t acquired by any temperature sensor ≥T, proceeding to step S3; otherwise, returning to S1 for continued monitoring;
   S3: Activation of the cooling and heat insulation module for cooling:
based on an identification number of the temperature sensor, issuing, by the processor, a command to open, via a corresponding branch solenoid valve drive circuit, the two branch solenoid valves associated with the temperature sensor, thereby initiating circulation of the coolant into a liquid cooling plate of a corresponding cooling and heat insulation module, achieving rapid cooling of an overheated battery pack.

### Advantageous Effects of the Present Invention Relative to the Prior Art:

1. According to the present invention, by tightly inserting a battery pack between two adjacent cooling and heat insulation modules, transferring the heat generated by the battery pack through highly thermally conductive liquid cooling plates to the coolant and environment, thus greatly improving the heat dissipation capability of the battery pack.
2. The battery packs are dispersed between cooling and heat insulation modules; when a single battery undergoes thermal runaway, the thermal runaway is confined within that single battery, blocking heat transfer from high-temperature battery packs to low-temperature ones, effectively preventing propagation of thermal runaway.
3. The cooling system in the present invention can supply low-temperature coolant to the cooling and heat insulation modules, achieving rapid heat dissipation and cooling of the batteries.
4. The present invention has advantages such as energy saving, simple structure, high heat dissipation, and effective heat insulation. It requires no additional energy consumption and has no adverse effects on the battery pack. Even in cases of false or missed thermal runaway warnings, the rapid cooling and strong heat insulation module remains functional and reusable. It resolves the contradiction between thermal runaway isolation and system heat dissipation in battery systems, is suitable for energy storage batteries, and has excellent market prospects.

### BRIEF DESCRIPTION OF THE DRAWINGS

FIG. 1 is a schematic diagram of a battery pack case;

FIG. 2 is a schematic diagram of a heat insulation module, where a first liquid cooling pipeline is not shown;

FIG. 3 is a schematic diagram of a bottom liquid cooling plate, where a second liquid cooling pipeline is not shown;

FIG. 4 is a block diagram showing a flow direction of a coolant circulation, where dashed arrows indicate controlled coolant flow;

FIG. 5 is an overall axonometric view of an embodiment apparatus, where liquid coolant transmission pipelines and a cover of a battery pack case are not shown;

FIG. 6 is a control block diagram of thermal runaway treatment;

FIG. 7 is an overall exploded view of an embodiment apparatus, where liquid coolant transmission pipelines are not shown;

FIG. 8 is a schematic diagram showing a connection relationship between a second inlet, a second outlet of a bottom liquid cooling plate and an internal second liquid cooling pipeline;

FIG. 9 is a graph showing a rate of temperature change of batteries with and without a cooling and heat insulation module; and

FIGS. 10A-10D are graphs showing the rate of temperature change of lithium-ion batteries under different conditions, including without a cooling and heat insulation module (FIG. 10A) and with the module at different coolant temperatures of 12° C. (FIG. 10B), 17° C. (FIG. 10C), and 23° C. (FIG. 10D).

In the figures: 100 is a battery pack case, 101 is a cover plate, 102 is an elastic protrusion, 103 is a through-hole, 200 is a cooling and heat insulation module, 201 is a liquid cooling plate, 202 is an aerogel sheet, 203 is a metal hoop, 204 is a first inlet, 205 is a first outlet, 300 is a bottom liquid cooling plate, 301 is a second inlet, 302 is a second outlet, 400 is a cooling system, 401 is a coolant storage tank, 402 is a water pump, 403 is a compressor, 404 is a radiator, 405 is a condenser, 406 is a main pipeline, 407 is a branch solenoid valve, 408 is an angle valve diverter, 500 is a battery pack, 600 is a thermal runaway processing module, 601 is a temperature sensor, 602 is a processor, and 603 is a branch solenoid valve drive circuit.

### DETAILED DESCRIPTION OF THE INVENTION

The specific embodiments of the present invention will now be described in further detail below with reference to the accompanying drawings.

### EMBODIMENT 1

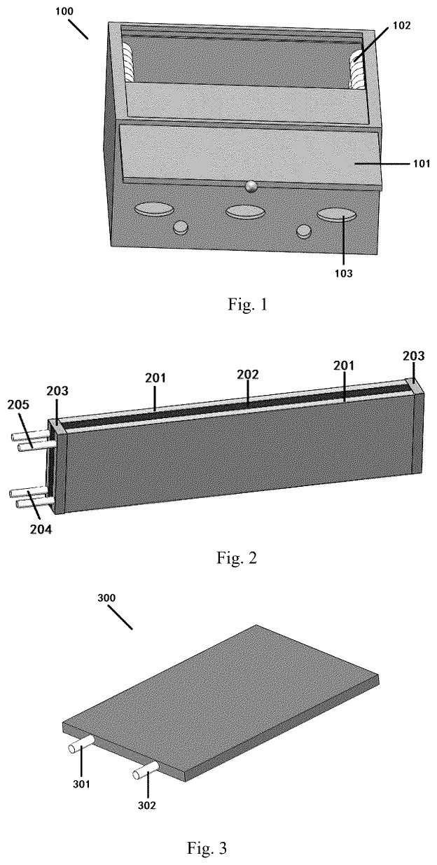

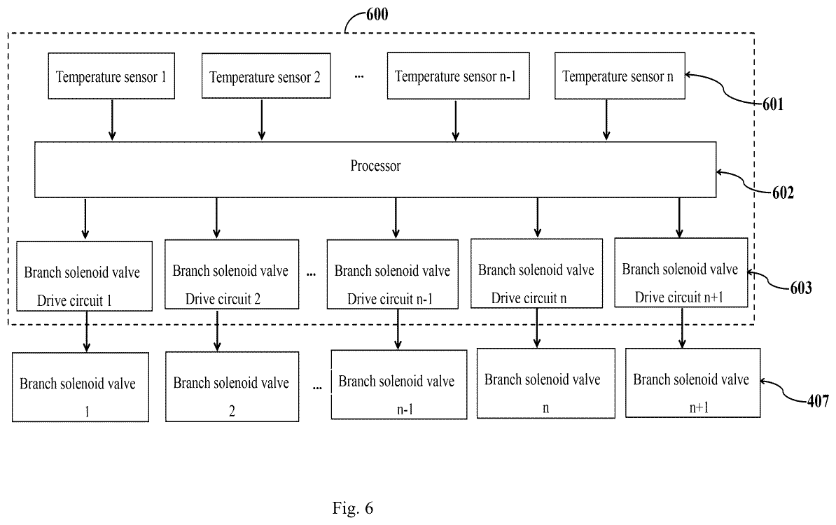

In the present embodiment, the battery pack 500 and the cooling and heat insulation module 200 are provided inside the battery pack case 100. The battery pack case 100 is referred to in FIGS. 1, 6, and 7, which features a pull-out sliding cover plate 101, and one side panel is provided with a through-hole 103; the through-hole 103 is used for the inlet and outlet of the liquid cooling plate, and its position and shape only need to match the inlet and outlet of the liquid cooling plate and facilitate the assembly of fluid delivery pipelines. It may be a circular, elliptical, or square hole. In the present embodiment, elastic protrusions 102 are provided on the inner walls of both side panels in the length direction of the battery pack case 100, which can not only mitigate external forces such as impacts but also ensure tight contact between the battery pack and the cooling and heat insulation module. The elastic protrusions 102 can be made of rubber, plastic, or fabric with flame-retardant properties and fixed to the side panels by adhesive or nails.

Referring to FIG. 2, the cooling and heat insulation module 200, including its structure and materials, is one of the inventive points of the present application. It consists of two liquid cooling plates 201 and one aerogel sheet 202, with the aerogel sheet 202 sandwiched between the two liquid cooling plates 201 and clamped at both ends by metal hoops 203 to form an integral unit. The overall thickness of the insulation module 200 should be less than one-quarter of the thickness of the battery pack 500. Each liquid cooling plate 201 is provided with a first inlet 204 and a first outlet 205, and internally contains a first liquid cooling pipeline communicating with the first inlet 204 and the first outlet 205, for inputting and outputting a coolant.

For the positional and connection relationships among the first inlet 204, first outlet 205, and the first liquid cooling pipeline, referring to FIG. 8, which shows the positional and connection relationships of the second inlet 301, the second outlet 302, and the internal second liquid cooling pipeline of the bottom liquid cooling plate 300, and these are identical. The zigzag parallel lines in the figure represent the second liquid cooling pipeline.

The aerogel sheet 202 is made of silica aerogel composite material, which has a low thermal conductivity coefficient, preventing heat transfer between the two liquid cooling plates 201 in the insulation module 200, and thus preventing heat transfer between two battery packs 500. When selecting the material, one with a thermal conductivity coefficient below 0.02 W/(m⋅K), good mechanical properties (elastic modulus of greater than 1500 kPa), and good flame retardancy is selected, effectively blocking lateral heat transfer and preventing propagation of battery pack thermal runaway; the thickness of the aerogel sheet should be less than 2 mm.

Referring to FIG. 3, the bottom liquid cooling plate 300 is laid on the inner bottom plate of the battery pack case 100. The bottom liquid cooling plate 300 is provided with a second inlet 301 and a second outlet 302, and internally contains a second liquid cooling pipeline communicating with the second inlet 301 and the second outlet 302, for inputting and outputting the coolant.

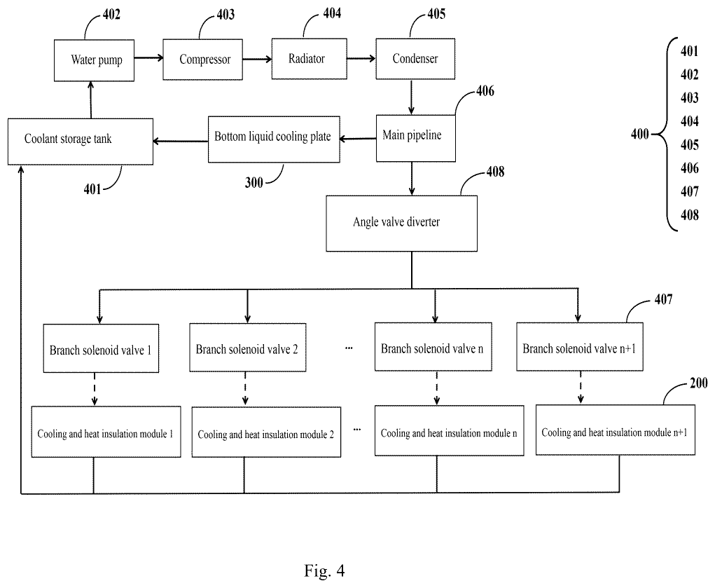

The structure, material selection, and shape of the bottom liquid cooling plate 300 and the liquid cooling plate 201 are completely identical, differing only in dimensions to suit the battery pack case 100. Both of them and their internal liquid cooling pipelines should be made of metals or composite materials with high thermal conductivity coefficients. The liquid cooling plate should be made of metal with a thermal conductivity coefficient of greater than 200 W/(m⋅K), and the liquid cooling pipeline should be made of metal with a thermal conductivity coefficient of greater than 300 W/(m⋅K), enabling timely transfer of heat generated by the battery and improving heat dissipation performance; the material selection and parameters of the metal hoop 203 also follow this standard. Referring to FIG. 4, the cooling system 400 circulates coolant to the liquid cooling plates 201 and the bottom liquid cooling plate 300. It includes a coolant storage tank 401, and a water pump 402, a compressor 403, a radiator 404, a condenser 405 and a main pipeline 406 which are sequentially connected via pipelines using the coolant from the coolant storage tank 401; wherein the main pipeline 406 delivers the coolant to the bottom liquid cooling plate 300 and then circulates back to the coolant storage tank 401 to maintain continuous circulation. Another branch passes through the angle valve diverter 408, n+1 branch solenoid valves 407, and n+1 branch pipelines to supply coolant to each liquid cooling plate 201 before returning to the coolant storage tank 401; the branch solenoid valves 407 are normally closed valves; the supply of coolant to each liquid cooling plate 201 via the respective branch solenoid valves 407 is controlled by the thermal runaway processing module 600.

The battery pack 500 is a lithium-ion battery pack. A single battery pack case 100 can accommodate a plurality of battery packs 500, at least one set. The number of accompanying cooling and heat insulation modules 200 is one more than the number of battery packs, ensuring that each battery pack 500 is sandwiched between two cooling and heat insulation modules 200.

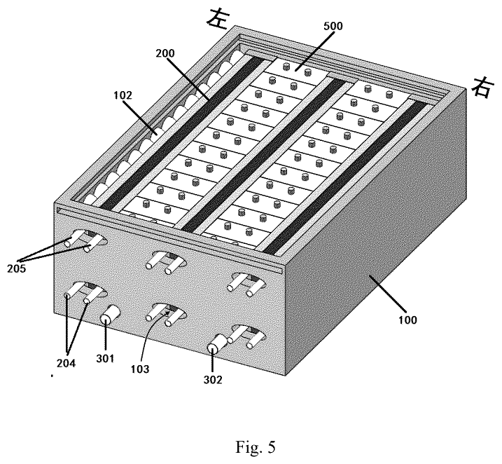

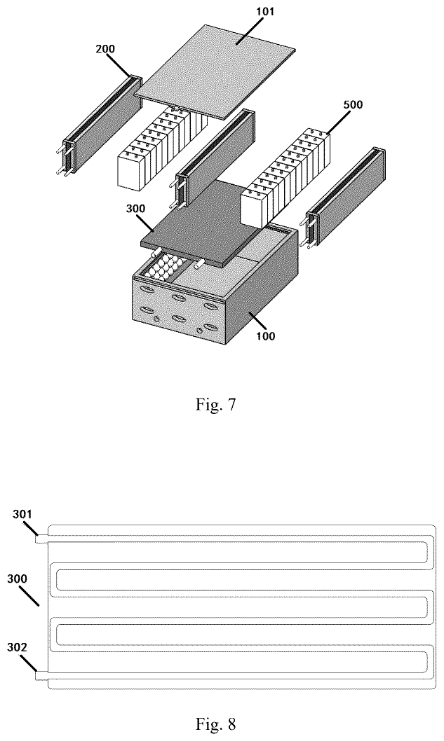

Referring to FIGS. 5 and 7, in the present embodiment, two battery packs 500 are paired with three cooling and heat insulation modules 200. The cooling and heat insulation modules 200 are provided in a row on the bottom liquid cooling plate 300, with one battery pack 500 tightly inserted between every two adjacent cooling and heat insulation modules 200. The first inlets 204 and first outlets 205 of each liquid cooling plate 201, as well as the second inlet 301 and second outlet 302 of the bottom liquid cooling plate 300, extend out of the battery pack case 100 through the through-holes 103 and connect to fluid delivery pipelines.

The elastic protrusions 102 on the inner side walls of the battery pack case 100 are in contact with the cooling and heat insulation modules 200, ensuring tight contact between each battery pack 500 and the two adjacent cooling and heat insulation modules 200, thereby guaranteeing heat transfer effectiveness between the battery pack 500 and the cooling and heat insulation modules 200.

The positional relationship, ratio, and connection relationship among the elastic protrusions 102, the battery pack 500, and the cooling and heat insulation module 200 constitute another inventive point of the present application.

Please refer to FIG. 5. For the convenience of description, the components from left to right are defined as the first cooling and heat insulation module 200, the first battery pack 500, the second cooling and heat insulation module 200, the second battery pack 500, and the third cooling and heat insulation module 200. The elastic protrusion 102 on the left wall is in tight contact with the first cooling and heat insulation module 200, which is in turn in tight contact with the first battery pack 500, followed by tight contact between the first battery pack 500 and the second cooling and heat insulation module 200, then between the second cooling and heat insulation module 200 and the second battery pack 500, then between the second battery pack 500 and the third cooling and heat insulation module 200, and finally the third cooling and heat insulation module 200 is in tight contact with the elastic protrusion 102 on the right wall. The first inlets 204 and first outlets 205 on the liquid cooling plates 201 of the first, second, and third cooling and heat insulation modules 200 are respectively connected to the first, second, and third branch pipelines and the first, second, and third branch solenoid valves 407.

Referring to FIGS. 4 and 5, the thermal runaway processing module 600 includes temperature sensors 601 placed inside the battery pack case 100 for detecting the temperature of the battery pack 500, and a processor 602 and n+1 branch solenoid valve drive circuits 603 located outside the battery pack case 100.

One temperature sensor 601 is provided for each battery pack 500, each assigned a unique number consistent with the positional information of the corresponding battery pack 500. The signal output terminal of each temperature sensor 601 is electrically connected to the corresponding signal input terminal of the processor 602, and the n+1 branch solenoid valve drive circuits 603 are respectively electrically connected to the signal output terminals of the processor 602. Each branch solenoid valve drive circuit 603 has a unique number, and the number of the temperature sensor 601 set for each battery pack 500 is associated with the numbers of the two branch solenoid valve drive circuits 603 corresponding to the two adjacent cooling and heat insulation modules 200.

In the present embodiment, two temperature sensors 601 and three branch solenoid valve drive circuits 603 are provided. Please refer to FIG. 5, where the components are defined, from left to right, as the first branch solenoid valve drive circuit 603, the first temperature sensor 601, the second branch solenoid valve drive circuit 603, the second temperature sensor 601, and the third branch solenoid valve drive circuit 603. Thus, the number of the first temperature sensor 601 is associated with the numbers of the first and second branch solenoid valve drive circuits 603; the number of the second temperature sensor 601 is associated with the numbers of the second and third branch solenoid valve drive circuits 603.

Each branch solenoid valve drive circuit 603 is electrically connected to one branch solenoid valve 407. In the present embodiment, the first, second, and third branch solenoid valve drive circuits 603 are respectively connected to the first, second, and third branch solenoid valves 407.

When the temperature sensor 601 detects that the temperature of the battery pack 500 exceeds the thermal runaway warning temperature, the processor 602 issues instructions to activate the two associated branch solenoid valve drive circuits 603 to open the corresponding branch solenoid valves 407.

In the present embodiment, if the temperature sensor 601 detects that the temperature of the first battery pack 500 exceeds the thermal runaway warning temperature, the processor 602 issues instructions to activate the first and second branch solenoid valve drive circuits 603, opening the first and second solenoid valves 407. The main pipeline 406, via the angle valve diverter 408, sends coolant through the first solenoid valve 407 into the first inlets 204 of the liquid cooling plates 201 on both sides of the first cooling and heat insulation module 200. The coolant flows through the first liquid cooling pipeline inside the liquid cooling plate 201 and exits via the first outlet 205, returning through fluid pipelines to the coolant storage tank 401. Simultaneously, the coolant is sent via the second solenoid valve 407 into the first inlets 204 of the liquid cooling plates 201 on both sides of the second cooling and heat insulation module 200, flows through the first liquid cooling pipeline, exits via the first outlet 205, and returns to the coolant storage tank 401.

If the temperature sensor 601 detects that the temperature of the second battery pack 500 exceeds the thermal runaway warning temperature, the processor 602 issues instructions to activate the second and third branch solenoid valve drive circuits 603, opening the second and third solenoid valves 407. The main pipeline 406, via the angle valve diverter 408, sends coolant through the second solenoid valve 407 into the first inlets 204 of the liquid cooling plates 201 on both sides of the second cooling and heat insulation module 200. The coolant flows through the first liquid cooling pipeline inside the liquid cooling plate 201 and exits via the first outlet 205, returning through fluid pipelines to the coolant storage tank 401. Simultaneously, the coolant is sent via the third solenoid valve 407 into the first inlets 204 of the liquid cooling plates 201 on both sides of the third cooling and heat insulation module 200, flows through the first liquid cooling pipeline, exits via the first outlet 205, and returns to the coolant storage tank 401.

The thermal runaway warning temperature is set according to actual application scenarios. In the present embodiment, the thermal runaway warning temperature is set to 50° C.

The cooling and heat insulation modules 200 and battery packs 500 are alternately provided. Heat generated by the battery pack 500 is transferred via the highly thermally conductive liquid cooling plates 201 to the coolant and environment, greatly enhancing the heat dissipation capacity of the battery pack. The coolant solution flowing through the liquid cooling plates 201 has a low vaporization temperature and high heat absorption capacity, capable of absorbing heat transferred from the liquid cooling plates 201, rapidly cooling the battery, improving temperature uniformity, and isolating heat generated by a thermally runaway individual cell, thereby confining thermal runaway to a single cell and preventing chain reaction thermal runaway in the battery pack.

To further optimize the cooling and heat insulation effect, the following measures are additionally adopted in the present embodiment:
A thickness of the aerogel sheet 202 is less than 2 mm, and a silica aerogel composite material selected has a thermal conductivity coefficient of less than 0.02 W/(m⋅K) and an elastic modulus of greater than 1500 kPa.
A material of the liquid cooling plate 201 is a metal having a thermal conductivity coefficient of greater than 200 W/m⋅K, and a material of the liquid cooling pipeline is a metal having a thermal conductivity coefficient of greater than 300 W/m⋅K.
A thickness of each cooling and heat insulation module 200 is less than one-quarter of a thickness of each battery pack 500.

The cooling system 400 circulates a coolant that is either distilled water or an ethylene glycol aqueous solution, and a circulation flow rate V ensures that a maximum temperature of the battery pack 500 during normal operation remains below 40° C. Additionally, the circulation flow rate V must ensure that after a thermal runaway warning, the heat dissipation efficiency of the liquid cooling plate 201 is greater than or equal to 1° C./min.

The coolant in the coolant storage tank 401 shall satisfy a supply capacity of more than 6 minutes under the circulation flow rate V without reflux; a maximum flow rate of the coolant provided by the water pump 402 is greater than or equal to the circulation flow rate V.

The cooling system 400 further comprises a semiconductor device and a phase change material, which are attached and wrapped on each branch pipeline for cooling and reducing a temperature of the branch pipelines. In the present embodiment, the semiconductor device model is TEC1-12710, and the phase change material is paraffin/aluminum foam. The semiconductor devices are attached and wrapped around each branch pipeline, the phase change material is further wrapped over the semiconductor device, and both are fixed using securing measures such as placing a box or sleeve over the phase change material.

### EMBODIMENT 2

A control method for rapid cooling and strong heat insulation emergency disposal after thermal runaway warning of lithium-ion batteries, wherein based on the rapid cooling and strong heat insulation device for emergency disposal after thermal runaway warning of energy storage lithium-ion batteries described above, the thermal runaway warning temperature T of the energy storage lithium-ion battery is set as 50° C., the specific control method comprising the following steps:

### S1: Detection:

each temperature sensor 601 acquires in real time a temperature t of a corresponding battery pack 500 and transmits same to the processor 602;

### S2: Judgment:

after receiving the real-time temperatures acquired by respective temperature sensors, the processor 602 compares the real-time temperatures with a thermal runaway warning temperature T; if the temperature t acquired by any temperature sensor ≥T, proceed to step S3; otherwise, return to S1 for continued monitoring;
   S3: Activation of the cooling and heat insulation module for cooling:
based on an identification number of the temperature sensor 601, the processor 602 issues a command to open, via a corresponding branch solenoid valve drive circuit 603, the two branch solenoid valves associated with the temperature sensor 601, thereby initiating circulation of the coolant into a liquid cooling plate 201 of a corresponding cooling and heat insulation module 200, achieving rapid cooling of an overheated battery pack.

To verify the rapid cooling and strong heat insulation capability of the embodiment, the following analysis is conducted through two examples.

### Verification Test 1:

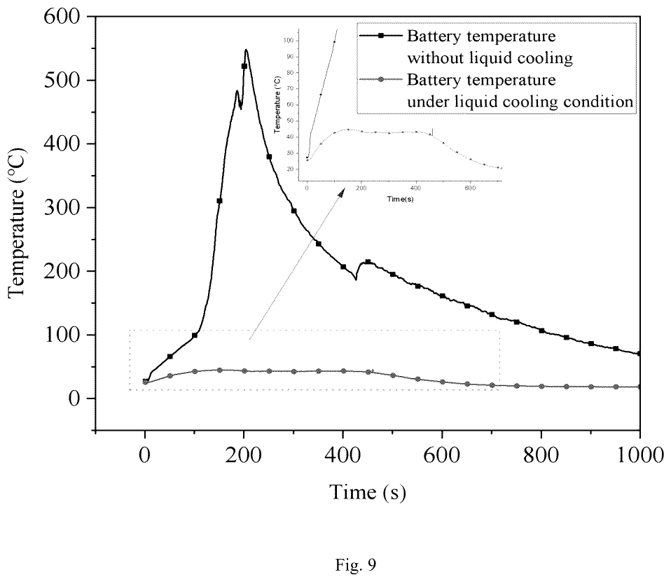

To verify the rapid cooling and strong heat insulation capability of the cooling and heat insulation module 200, two cooling and heat insulation modules 200 are closely attached to the battery cell, using distilled water as the coolant, with a coolant flow rate of 1 L/min and coolant temperature of 10° C. An external short-circuit triggering device is used to trigger an external short circuit of the battery cell. Simultaneously with the external short circuit of the battery cell, the liquid cooling device is activated, and the temperature changes of lithium-ion batteries with and without the cooling and heat insulation module 200 are compared. As shown in FIG. 9, under the condition without heat dissipation from the cooling and heat insulation module, the temperature of battery cell rises to 548° C. at approximately 200 s, indicating thermal runaway has occurred. Under the condition with heat dissipation from the cooling and heat insulation module, the maximum temperature of the lithium-ion battery is 45.58° C., remaining within the normal operating range. This indicates that the cooling and heat insulation module 200 can prevent the occurrence of battery thermal runaway.

### Verification Test 2:

To verify the effectiveness of the rapid cooling and strong heat insulation performance of the cooling and heat insulation module 200, one cooling and heat insulation module 200 is closely attached to the battery cell, using distilled water as the coolant, with a coolant flow rate of 1.5 L/min and coolant temperatures of 12° C., 17° C., and 23° C. A heating plate with a power of 500 W is used to heat the battery to trigger thermal runaway of the battery cell. Simultaneously with heating the battery cell, the liquid cooling device is activated, and the temperature change rates of the lithium-ion battery under conditions with and without the cooling and heat insulation module 200 and under different coolant temperatures are compared.

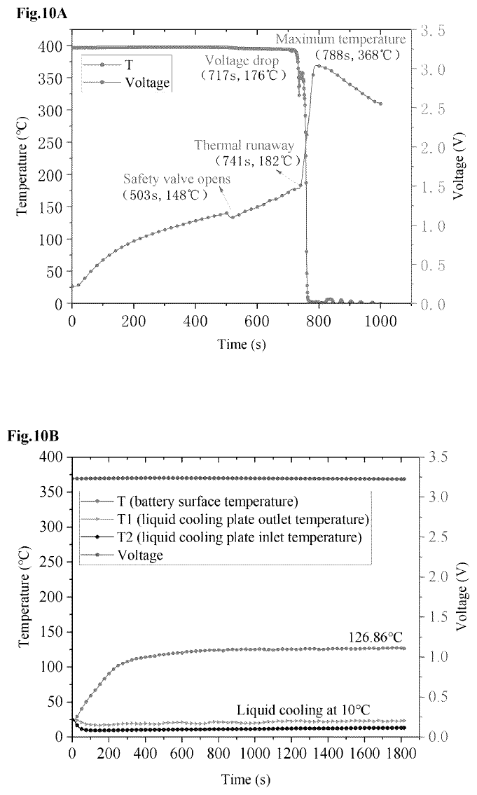

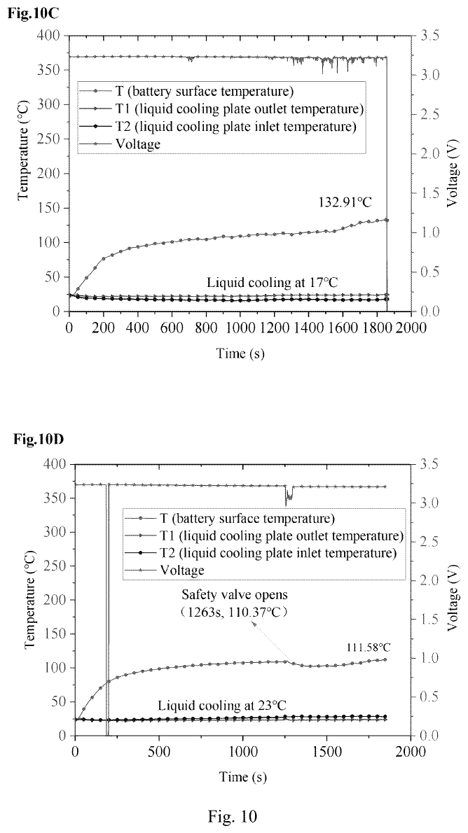

As shown in FIG. 10A, under the condition without heat dissipation from the cooling and heat insulation module, thermal runaway occurs at 741 s of heating, during which the temperature rapidly increases from 182° C. to 368° C. within a short time.

As shown in FIG. 10B, under the condition with heat dissipation from the cooling and heat insulation module, the coolant temperature is 12° C. After 1800 s of heating, the temperature of the battery cell reaches 126.86° C., without thermal runaway occurring. Moreover, after 300 s of heating, the battery temperature stabilizes around 126° C., providing ample time for personnel evacuation and implementation of other measures.

The experimental condition corresponding to FIG. 10C is: under the condition with heat dissipation from the cooling and heat insulation module, the coolant temperature is 17° C. The experimental condition corresponding to FIG. 10D is: under the condition with heat dissipation from the cooling and heat insulation module, the coolant temperature is 23° C. As shown in FIGS. FIG. 10C and FIG. 10D, as the coolant temperature increases, the maximum battery temperature first rises and then decreases. In FIG. 10D, when the coolant temperature is 23° C., although the maximum battery temperature is the lowest, the battery safety valve opens at 1263 s of heating, causing heat loss through the safety valve, rendering the battery unusable. As further shown in FIG. 10, when the coolant temperature is 17° C. and 23° C., the battery temperature still shows a rapid upward trend at 1800 s. However, when the coolant temperature is 12° C., the battery temperature gradually stabilizes with prolonged heating time. Furthermore, at a coolant temperature of 17° C., significant battery swelling occurs, making it unusable again. Therefore, existing liquid cooling thermal management systems using coolants at 25° C. or even higher temperatures cannot prevent battery failure or thermal runaway. To prevent thermal runaway or failure of lithium-ion batteries, the coolant temperature should be 12° C. or even lower.

In summary, the rapid cooling and strong heat insulation device for emergency disposal after thermal runaway warning of energy storage lithium-ion batteries according to the present invention can effectively cool down the battery pack and insulate individual cells, prevent battery thermal runaway under external short circuit and external heating conditions, and enable effective emergency disposal after a thermal runaway warning, thereby improving the safety of the battery pack. The present invention solves the shortcomings of existing liquid cooling systems and has advantages such as energy saving, high heat dissipation, simple structure, and effective heat insulation. Even if there is a false alarm or missed alarm of thermal runaway warning, the rapid cooling and strong heat insulation module can still function and can be reused. It resolves the contradiction between thermal runaway isolation and system heat dissipation in battery systems, is suitable for energy storage batteries, and has broad market prospects.

The present embodiment is merely exemplary explanation of the present patent and does not limit its protection scope. Those skilled in the art can make improvements and refinements without departing from the principles of the present invention, and such improvements and refinements should also be considered within the protection scope of the present invention.

1. A rapid cooling and strong heat insulation device for emergency disposal after thermal runaway warning of energy storage lithium-ion batteries, comprising:
a battery pack case (100) provided with a slidable top cover plate (101), wherein one sidewall is provided with a plurality of through-holes (103);
n+1 cooling and heat insulation modules (200) provided in the battery pack case (100), each comprising two liquid cooling plates (201) and one aerogel sheet (202), with the aerogel sheet (202) sandwiched between the two liquid cooling plates (201), both ends being clamped together as a whole by metal hoops (203), each liquid cooling plate (201) being provided with a first inlet (204) and a first outlet (205), and the liquid cooling plate (201) internally provided with a first liquid cooling pipeline communicating with the first inlet (204) and the first outlet (205), for inputting and outputting a coolant; n being a positive integer;
a bottom liquid cooling plate (300) laid on an inner bottom plate of the battery pack case (100), the bottom liquid cooling plate (300) being provided with a second inlet (301) and a second outlet (302), and internally provided with a second liquid cooling pipeline communicating with the second inlet (301) and the second outlet (302), for inputting and outputting the coolant; wherein the n+1 cooling and heat insulation modules (200) are provided in a row on the bottom liquid cooling plate (300), with a set of battery packs (500) tightly inserted between two adjacent cooling and heat insulation modules (200), resulting in a total of n sets of battery packs (500);
a cooling system (400) for circulating the coolant to the liquid cooling plate (201) and the bottom liquid cooling plate (300), comprising a coolant storage tank (401), and a water pump (402), a compressor (403), a radiator (404), a condenser (405) and a main pipeline (406) which are sequentially connected via pipelines using the coolant from the coolant storage tank (401); wherein the main pipeline (406) delivers the coolant to the bottom liquid cooling plate (300) and then circulates back to the coolant storage tank (401), while another branch passes through an angle valve diverter (408), n+1 branch solenoid valves (407), and n+1 branch pipelines to deliver the coolant to each liquid cooling plate (201) before returning to the coolant storage tank (401); all the branch solenoid valves (407) are normally closed valves; the first inlets (204) and first outlets (205) of the liquid cooling plates (201) of each cooling and heat insulation module (200), as well as the second inlet (301) and second outlet (302) of the bottom liquid cooling plate (300), extend out of the battery pack case (100) through the through-holes (103) and connect to fluid delivery pipelines; and
a thermal runaway processing module (600) comprising temperature sensors (601) provided inside the battery pack case (100) for detecting the temperature of the battery packs (500), and a processor (602) and n+1 branch solenoid valve drive circuits (603) provided outside the battery pack case (100); one temperature sensor (601) is provided at each battery pack (500), each temperature sensor (601) having a unique identification number consistent with positional information of the corresponding battery pack (500); a signal output terminal of each temperature sensor (601) is electrically connected to a corresponding signal input terminal of the processor (602), the n+1 branch solenoid valve drive circuits (603) being respectively electrically connected to the signal output terminal of the processor (602), each branch solenoid valve (407) having a unique identification number, the identification number of the temperature sensor (601) installed at each battery pack (500) being associated with the identification numbers of the two branch solenoid valve drive circuits (603) of the adjacent cooling and heat insulation modules (200), each branch solenoid valve drive circuit (603) being electrically connected to one branch solenoid valve (407); when the temperature sensor (601) detects that the temperature of any battery pack (500) exceeds a thermal runaway warning temperature, the processor (602) issues a command to activate the associated branch solenoid valve drive circuit (603) to open the corresponding branch solenoid valve (407).

2. The rapid cooling and strong heat insulation device for emergency disposal after thermal runaway warning of energy storage lithium-ion batteries according to claim 1, wherein a thickness of the aerogel sheet (202) is less than 2 mm, and a silica aerogel composite material selected has a thermal conductivity coefficient of less than 0.02 W/(m⋅K) and an elastic modulus of greater than 1500 kPa.

3. The rapid cooling and strong heat insulation device for emergency disposal after thermal runaway warning of energy storage lithium-ion battery according to claim 1, wherein a material of the liquid cooling plate (201) is a metal having a thermal conductivity coefficient of greater than 200 W/m⋅K, and a material of the liquid cooling pipeline is a metal having a thermal conductivity coefficient of greater than 300 W/m⋅K.

4. The rapid cooling and strong heat insulation module according to claim 3, wherein a thickness of each cooling and heat insulation module (200) is less than one-quarter of a thickness of each battery pack (500).

5. The rapid cooling and strong heat insulation device for emergency disposal after thermal runaway warning of energy storage lithium-ion batteries according to claim 4, wherein the cooling system (400) circulates a coolant selected from distilled water or ethylene glycol aqueous solution, and a circulation flow rate V is such that a maximum temperature of the battery pack (500) during normal operation is maintained below 40° C., and the circulation flow rate V further ensures that the heat dissipation efficiency of the liquid cooling plate (201) after the thermal runaway warning is greater than or equal to 1° C./min.

6. The rapid cooling and strong heat insulation device for emergency disposal after thermal runaway warning of energy storage lithium-ion batteries according to claim 5, wherein the coolant in the coolant storage tank (401) shall satisfy a supply capacity of more than 6 minutes under the circulation flow rate V without reflux; a maximum flow rate of the coolant provided by the water pump (402) is greater than or equal to the circulation flow rate V.

7. The rapid cooling and strong heat insulation device for emergency disposal after thermal runaway warning of energy storage lithium-ion batteries according to claim 1, wherein the cooling system (400) further comprises a semiconductor device and a phase change material, which are attached and wrapped on each branch pipeline for cooling and reducing a temperature of the branch pipelines.

8. The rapid cooling and strong heat insulation device for emergency disposal after thermal runaway warning of energy storage lithium-ion batteries according to claim 1, wherein elastic protrusions (102) are provided on inner walls of two side panels of the battery pack case (100), the two side panels being adjacent to a side panel provided with the through-holes (103); the through-holes (103) are any one or a combination of more than one of circular holes, oval holes and square holes.

9. A control method for rapid cooling and strong heat insulation emergency disposal after thermal runaway warning of lithium-ion batteries, wherein based on the rapid cooling and strong heat insulation device for emergency disposal after thermal runaway warning of energy storage lithium-ion batteries according to claim IS, setting the thermal runaway warning temperature of the energy storage lithium-ion battery as T, the specific control method comprising the following steps:
S1: Detection:
acquiring in real time, by each temperature sensor (601), a temperature t of a corresponding battery pack (500) and transmitting same to the processor (602);
S2: Judgment:
after receiving the real-time temperatures acquired by respective temperature sensors, comparing, by the processor (602), the real-time temperatures with a thermal runaway warning temperature T;
if the temperature t acquired by any temperature sensor ≥T, proceeding to step S3; otherwise, returning to S1 for continued monitoring;
S3: Activation of the cooling and heat insulation module for cooling:
based on an identification number of the temperature sensor (601), issuing, by the processor (602), a command to open, via a corresponding branch solenoid valve drive circuit (603), the two branch solenoid valves associated with the temperature sensor (601), thereby initiating circulation of the coolant into a liquid cooling plate (201) of a corresponding cooling and heat insulation module (200), achieving rapid cooling of an overheated battery pack.
